(19) United States
(12) Patent Application Publication
(10) Pub. No.: US 2026/0221493 A1
(43) Pub. Date: Jul. 30, 2026

(54) MACROMONOMER AND SOLID-STATE POLYMER ELECTROLYTE

(71) Applicant: Evonik Operations GmbH, Essen (DE)

(72) Inventors: Jan Blankenburg, Weiterstadt (DE); Christos Sarigiannidis, Dortmund (DE); Frauke Henning, Essen (DE); Sebastian Bestgen, Wuerzburg (DE); Thorben Schütz, Alsbach-Haehnlein (DE); Frank Schubert, Neukirchen-Vluyn (DE)

(73) Assignee: Evonik Operations GmbH, Essen (DE)

(21) Appl. No.: 19/146,681

(22) PCT Filed: Jan. 10, 2024
(86) PCT No.: PCT/EP2024/050430

§ 371 Date: Jul. 9, 2025

(30) Foreign Application Priority Data
Jan. 11, 2023 (WO) PCT/EP2023/050555

(51) Int. Cl. H01M 10/056; C08G 65/26; C08G 65/332; C08G 77/46; H01M 10/0525

(52) U.S. Cl. CPC H01M 10/056; C08G 65/2609; C08G 65/3322; C08G 77/46; H01M 10/0525; H01M 2300/0082; H01M 2300/0091

(57) ABSTRACT

The invention provides a macromonomer, an electrolyte precursor composition comprising the macromonomer, a method to prepare a solid-polymer electrolyte, a solid-polymer electrolyte, a solid-state lithium secondary battery, an electrochemical device and a device.

### TECHNICAL FIELD

The invention relates to polymer electrolytes, which are particularly useful for solid-state lithium-ion batteries.

### BACKGROUND ART

In a solid-state battery, the solid-state electrolyte replaces both the function of the separator and the electrolyte. In order to function as a separator which prevents a short cut between anode and cathode, the solid-state electrolyte needs mechanical stability, while having high ionic conductivity at room temperature to be able to shuttle lithium ions between cathode and anode.

Zhang, X.; Daigle, J. C.; Zaghib, K. Comprehensive review of polymer architecture for all-solid-state lithium rechargeable batteries. Materials (Basel). 2020, 13, 2488 summarizes influences of polymer architecture on the physical and electrochemical properties of an SPE in lithium solid polymer batteries. The discussion mainly focuses on four principal categories: linear, comb-like, hyper-branched, and crosslinked polymers. There remain three main problems in PEO-based SPEs that should be resolved: low ionic conductivity at low temperatures, low transference number, and relatively narrow electrochemical window when a high-voltage cathode is used.

Nair, J. R., Destro, M., Gerbaldi, C. et al. Novel multiphase electrode/electrolyte composites for next generation of flexible polymeric Li-ion cells. J Appl Electrochem 43, 137-145 (2013) discloses a methacrylic-based polymer electrolyte directly formed in situ at the interface of different electrode films (i.e., commercial graphite and hydrothermally synthesized LiFePO₄). The polymer electrolyte was prepared using the materials including bisphenol A ethoxylate (15 EO/phenol) dimethacrylate (BEMA), a methacrylic-based di-functional oligomer having an average molecular weight of 1,700 and poly(ethylene glycol) methyl ether methacrylate (PEGMA-475, average Mn: 475) under UV-irradiation. Upon exposure to UV-irradiation, the polymer electrolyte membrane obtained by copolymerising the reactive mixture containing BEMA, PEGMA-475, LiTFSI and ECDEC (1:1 w/w) solution along with the photo-initiator was found to be transparent, self-standing, flexible, non-tacky and easy to handle.

Michiyuki Kono et al 1998 J. Electrochem. Soc. 145 1521 discloses a polymer electrolyte. When preparing the electrolyte, the terminal hydroxyl groups of poly(ethylene oxide-co-propylene oxide) triol (MW 7940) were partly methylated, and the residual hydroxyl groups were esterified by acrylic acid. The resulting macromonomers were cross-linked by photoirradiation in the presence of an electrolyte salt to produce the network polymer electrolytes. However, the electrochemical and the mechanical performance was to be further improved.

St-Onge, V., Cui, M., Rochon, S. et al. Reducing crystallinity in solid polymer electrolytes for lithium-metal batteries via statistical copolymerization. Commun Mater 2, 83 (2021) discloses EO-PO polyether copolymer alcohols that exhibit high ionic conductivity. The prepared copolymer contains around 300 EO units and a few comonomer units. It was discovered that ca 26 mol % of comonomer was sufficient to entirely obliterate polymer crystallinity leading to a PEO-rich material that is thermodynamically unable to crystallize. Statistical copolymers containing 18 mol % of comonomers with 18 wt % of LiTFSI are entirely devoid of crystallinity. Contrasting with the nature of the comonomer side chain, the comonomer content strongly impacts ionic conductivity. A low amount of comonomer results in a decrease of crystallite size and decrease in crystallinity content. Consequently, the ionic conductivity grows from 5×10⁻⁸ to 0.3×10⁻⁴ S cm⁻¹ by only adding 10 mol % of comonomer. Introducing larger amounts of comonomer in the SPE results in a conductivity drop, because the comonomers are not as efficient as EO units to dissolve and complex the Li⁺ salt. Thus, 10 mol % of comonomer units in the copolymer offers is the best compromise between reducing the crystallinity and increasing the EO content necessary for ionic conductivity. These copolymers have crystallinity contents of 19%, 12%, and 4%, and T_{g}s of −44° C., −50° C., and −72° C. for PO, BO, and TO units, respectively. After the copolymerization the copolymer was precipitated with 600 mL of hexanes and filtered. The precipitated polymer was dried under vacuum at room temperature for 24 h to give a white-yellowish powder. The polymer electrolyte was prepared as follows, in a nitrogen-filled glovebox, 820 mg of polymer was dissolved in 5-10 mL of anhydrous THF. Then, 180 mg of LiTFSI was added to the solution and dissolved at 65° C. The solvent was then evaporated under reduced pressure and dried under vacuum for 24 h. The electrolyte was kept in the nitrogen glovebox. However, the polymer electrolytes prepared using the copolymer alcohols showed poor mechanical performance.

U.S. Pat. No. 6,933,078B2 discloses a crosslinked polymer electrolyte that comprises a poly(ethylene glycol) methyl ether methacrylate (POEM) monomer crosslinked to a low Tg second monomer. The crosslinked polymer electrolytes such as POEM-X-PDMSD-LiN(CF₃SO₂)₂ and POEM-X-PDMSM-PEGDME-LiN(CF₃SO₂)₂ are disclosed. U.S. Pat. No. 6,933,078B2 does not disclose preparation of POEM-X-PDMSM-PEGDME-LiN(CF₃SO₂)₂ but mentioned that “it was found that the PDMSM could be easily grafted onto the POEM monomer but that the PDMSD could be easily crosslinked with the POEM monomer using the free radical synthesis method. (A PDMSM crosslinked polymer can be prepared using alternate synthesis methods.) The POEM-g-PDMSM polymer is a soluble electrolyte with a relatively lower conductivity and poor mechanical properties”. Example 4 discloses preparation of POEM-X-PDMSD-LiN(CF₃SO₂)₂ using POEM (14.8 ml), methacryloxypropyl terminated polydimethylsiloxane (PDMSD) (4.0 ml, ethyl acetate (96 ml), LiN(CF₃SO₂)₂ (1.8 g) add AIBN (0.072 g) by solution casting. The patent does not disclose the specific mechanical properties of the crosslinked polymer electrolytes prepared in the examples.

US20030180624A1 discloses an interpenetrating network solid polymer electrolyte comprising at least one branched siloxane polymer having one or more poly(alkylene oxide) branch as a side chain, at least one crosslinking agent, at least one monofunctional monomeric compound for controlling crosslinking density, at least one metal salt and at least one radical reaction initiator. In Examples 1-2, 0.4-2.0 g branched type siloxane polymer, 0.4 g poly(ethylene glycol-600) dimethacrylate (PEGDMA600) and 1.2-1.6 g poly(ethylene glycol) ethyl ether methacrylate (PEGEEMA) are used to prepare SPEs. During the preparation, porous polycarbonate membrane is used as a supporter for the IPN SPEs. Both of two IPN SPEs show high ionic conductivity over 10⁻⁵ S/cm at room temperature and as the content of branched type siloxane polymer is increased, so is the ionic conductivity.

### SUMMARY OF THE INVENTION

The invention aims to solve at least part of the problems in the art. This invention helps the production process of solid-polymer electrolyte by using a liquid starting formulation which can be crosslinked and solidified during solid-state battery production. This is achieved by a (meth)acrylate monomer with an amorphous side chain, which inhibits the crystallization. Furthermore, a polymer electrolyte using the (meth)acrylate monomer crosslinked by a siloxane monomer achieved surprisingly good mechanical performances and achieved surprisingly high ionic conductivity at low temperature such as below 40° C., especially below 20° C.

By designing a polyether-copolymer (meth)acrylate macromonomer, the mechanical properties related to the molecular weight of the polymer can be adjusted by polymerization. In this polymerization, a crosslinker is used to tailor the elastic properties of the resulting elastomeric material.

The invention provides a macromonomer, which is represented by the following general formula (I):

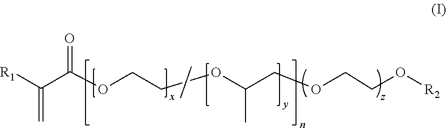

wherein R₁ represents methyl or H;
wherein z is the repeating number of an ethylene glycol spacer and represents 0, 1, 2, or 3;
R₂ represents methyl or a C2-C10 aliphatic or aromatic group, preferably methyl or ethyl, more preferably methyl;
n represents a positive integer from 10 to 200, preferably from 10 to 100, more preferably from 40 to 80; n defines the degree of polymerization of a random copolymer with the ratios of the comonomers x and y; and
y=1%-40%, preferably 5%-25%, more preferably 10%-20%, even more preferably 12%-18%, x=1-y.

The number average molecular weight of the macromonomer is typically from 500 to 10000, preferably 500-5000, for example, 600-4500, more preferably 750-4000, or 750-2000, even more preferably 800-1500, for example around 1000.

Preferably, the macromonomer is liquid at room temperature. Such liquid macromonomer includes the macromonomers wherein in formula (I),
wherein R₁ represents methyl or H;
wherein z is the repeating number of an ethylene glycol spacer and represents 0, 1, 2, or 3;
R₂ represents methyl or a C2-C5 aliphatic group, preferably methyl or ethyl, more preferably methyl;
n represents a positive integer from 10 to 100; n defines the degree of polymerization of a random copolymer with the ratios of the comonomers x and y;
y=10%-25%, preferably 14%-20%, x=1-y; and
the number average molecular weight of the macromonomer is from 500 to 5000, preferably 750-2000, more preferably 800-1500, for example around 1000.

The macromonomer is a poly(ethylene glycol-co-propylene glycol) alkyl ether (meth)acrylate.

The macromonomer of the invention has no crystalline domains. In other words, the polyether-copolymer (meth)acrylate macromonomer is amorphous. The macromonomer is anhydrous. It is a liquid at room temperature. Thus, no solvent is needed for handling it and it can be used as reactive diluent for formulation which does not need to be removed after reactions and does not lead to volatile organic compound (VOC).

In addition, using the macromonomer of the invention, electrolytes with good electrochemical performance such as high ionic conductivity, especially at low temperature and good mechanical performance such as mechanical stability or strength can be prepared.

The invention further provides a macromonomer composition, which comprises:
the macromonomer of the invention, and
less than 5 wt. %, for example less than 4 wt. %, less than 3 wt. %, less than 2 wt. %, preferably less than 1 wt. %, for example less than 0.9 wt. %, less than 0.8 wt. %, less than 0.7 wt. %, less than 0.6 wt. %, less than 0.5 wt. %, less than 0.4 wt. %, less than 0.3 wt. %, less than 0.2 wt. %, even less than 0.1 wt. %, of solvent, based on the total weight of the macromonomer composition;
wherein the number average molecular weight of the macromonomer is from 500 to 5000, preferably 750-2000, more preferably 800-1500.

The macromonomer composition is liquid at room temperature.

The solvent may include water, and suitable organic solvents such as alcohols, esters, ethers, ketones.

The amount of the macromonomer is typically above 90 wt. %, preferably above 95 wt. %, for example above 96 wt. %, 97 wt. %, 98 wt. %, more preferably above 99 wt. %, for example, above 99.1 wt. %, 99.2 wt. %, 99.3 wt. %, 99.4 wt. %, 99.5 wt. %, 99.6 wt. %, 99.7 wt. %, 99.8 wt. %, or 99.9 wt. %, based on the total weight of the macromonomer composition.

The macromonomers of formula (I) can be synthesized via transesterification, direct esterification with (meth)acrylic acid or via esterification with activated (meth)acrylic acid derivatives, such as (meth)acrylic acid anhydride or (meth)acrylic acid chloride. The amorphous monomers can be synthesized using procedures known in the art (or slight modifications thereof), such as WO2010003710A1 or WO2020035315A1 or EP0780360B1.

In some embodiments, the method to prepare the macromonomer of the invention comprises the following steps:
I) reacting a primary alcohol with ethylene oxide (EO) and propylene oxide (PO) under catalysis; and
II) reacting the reaction product of Step 1) with a (meth)acrylate under catalysis to obtain the macromonomer.

The macromonomer is amorphous poly(ethylene glycol-co-propylene glycol) alkyl ether (meth)acrylate.

A person skilled in the art can adjust the molar ratio of EO to PO and the molar ratio of EO and PO to the primary alcohol to obtain macromonomers with desired repeating units and the molecular weight.

The primary alcohol may be any mono-functional alcohol. For example, the mono-functional alcohol may be selected from methanol, methyl diglycol, methyl glycol, methyl triglycole, methoxypolyethylene glycols (MPEGs), and other polar monofunctional alcohols.

In some embodiments, the method to prepare the macromonomer of the invention comprises the following steps:
I) reacting a primary alcohol with ethylene oxide and propylene oxide to obtain a polyether; and
II) reacting the polyether with a methyl (meth)acrylate to obtain a poly(ethylene glycol-co-propylene glycol) methyl ether (meth)acrylate.

The invention further provides an electrolyte precursor composition (i.e., an electrolyte formulation), which comprises:
A) the macromonomer of the invention;
B) a siloxane monomer especially an acrylate functional siloxane monomer; and
C) a lithium salt, and optionally
D) a free radical initiator.

The lithium salt and free radical initiator (which may be irradiation or thermal) may be selected from those conventional in the art.

The electrolyte precursor composition can be free of any solvent including water and organic solvent. The electrolyte precursor composition comprises preferably less than 10 wt. %, for example less than 9 wt. %, less than 8 wt. %, less than 7 wt. %, less than 6 wt. %, more preferably less than 5 wt. %, for example less than 4 wt. %, less than 3 wt. %, less than 2 wt. %, even more preferably less than 1 wt. %, for example less than 0.9 wt. %, less than 0.8 wt. %, less than 0.7 wt. %, less than 0.6 wt. %, less than 0.5 wt. %, less than 0.4 wt. %, less than 0.3 wt. %, less than 0.2 wt. %, even less than 0.1 wt. %, of solvent including water and organic solvent, based on the total weight of the electrolyte precursor composition. In some embodiments, the electrolyte precursor composition is free of any organic solvent or water.

The electrolyte precursor composition may further comprise fillers. Examples of the fillers may include silicon oxides and metal oxides.

Therefore, the invention provides a liquid electrolyte precursor formulation that can be used for producing solid-state electrolyte of solid-state batteries. The liquid formulation can be solidified after the coating of the formulation onto the electrodes.

The invention further provides a method to prepare a solid-polymer electrolyte, comprising the following steps:
a) Provide an electrolyte precursor composition of the invention; and
b) Crosslink the liquid electrolyte precursor composition with irradiation or thermal treatment under the presence of a free radical initiator.

The method of irradiation (such as UV, electron) and thermal treatment may be conventional.

The invention further provides a solid-polymer electrolyte prepared according to the method of the invention, or obtained by curing the electrolyte precursor composition.

The electrolyte can be free of any solvent including water and organic solvent, and is preferably free of any solvent including water and organic solvent.

A clear and elastic film can be obtained via the method of the invention. The electrolyte outperforms the PEO SPE benchmark, especially at low temperatures.

The invention further provides a lithium-ion battery comprising the solid-polymer electrolyte according to the invention.

The invention further provides a solid-state lithium secondary battery, which comprises a cathode, a solid copolymer electrolyte according to the invention and an anode, preferably a lithium metal anode. The solid-state lithium secondary battery does not comprise a separator that is used in a liquid state lithium secondary battery.

The invention further provides a method to prepare a solid-state lithium secondary battery, comprising, Assembling a cathode, the solid copolymer electrolyte according to the invention, and an anode, preferably a lithium metal anode, to form a solid-state lithium secondary battery.

In the invention, the term “solid polymer electrolyte” refers to all-solid-state polymer electrolyte and/or quasi-solid-state polymer electrolyte. The solid polymer electrolyte in the invention is preferably all-solid-state polymer electrolyte. When it refers to the solid polymer electrolyte of the invention, the term “copolymer electrolyte” is used interchangeably with “polymer electrolyte” unless otherwise specified.

In the invention, “lithium secondary battery” includes lithium-ion secondary battery and lithium metal secondary battery.

The present invention further provides an electrochemical device comprising the solid polymer electrolyte according to the present invention.

In some examples, the electrochemical device is a secondary battery, e.g. a lithium-ion battery, especially a lithium metal secondary battery.

The invention further provides a device, comprising the electrochemical device according to the invention. The device includes but not limited to, electric vehicles, electric home appliances, electric tools, portable communication devices such as mobile phones, consumer electronic products, and any other products that are suitable to incorporate the electrochemical device or lithium secondary battery of the invention as an energy source.

The invention further provides use of the macromonomer according to the invention, or use of the electrolyte precursor composition according to the invention, in preparation of a solid polymer electrolyte in a lithium secondary battery, especially a lithium metal secondary battery, particularly to improve performance such as electrolyte mechanical property, ionic conductivity especially at low temperatures such as 0-40° C., especially 0-20° C., for example 0-10° C., and/or cycling performance.

### Siloxane Monomer

The siloxane monomer is selected from organomodified siloxanes with ethylenically unsaturated, radically polymerizable groups. The ethylenically unsaturated, radically polymerizable groups are preferably selected from (meth-)acryloxy functions. The siloxane monomer is preferably selected from (meth-)acryloxy functionalized siloxanes with ethylenically unsaturated, radically polymerizable groups. The acryloxy functional group is required for an effective cross-linking.

The number of radically polymerizable groups in the siloxane monomer is typically 3 or more in order to ensure effective crosslinking.

The siloxane monomer is preferably selected from (meth-)acryloxy functionalized siloxanes having 4 to 40 silicon atoms, where 15% to 100% of the silicon atoms have ethylenically unsaturated, radically polymerizable groups.

In some embodiments, the siloxane monomer further comprises ester groups which are not radically polymerizable.

In some embodiments, the siloxane monomer is a compound of formula (II)

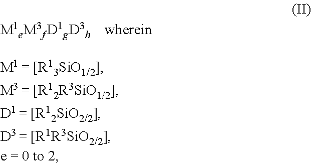

f=0 to 2, preferably zero, and e+f=2,
g=0 to 38, preferably 10 to 26,
h=0 to 20, for example 1 to 20, or 2 to 20, or 3 to 20, preferably 4 to 15,
and the ratio of the sum (f+h) to the sum (g+h+2) is from 0.15 up to 1, preferably 0.2 to 0.5,
and the sum (g+h+2) is 4 to 40, preferably 10 to 30,
R¹ denotes identical or different aliphatic hydrocarbons having 1 to 10 carbon atoms or aromatic hydrocarbons having 6 to 12 carbon atoms, preferably methyl and/or
phenyl groups, especially preferably methyl group,
R³ denotes identical or different hydrocarbons which have 1 to 5 identical or different ester, preferably (meth-)acryloxy functions, the hydrocarbon being linear, cyclic, branched and/or aromatic, preferably linear or branched, and the ester, preferably (meth-)acryloxy functions being selected from ethylenically unsaturated, radically polymerizable ester, preferably (meth-)acryloxy functions and from ester groups which are not radically polymerizable.

The ester function of R³ is preferably a (meth-)acryloxy function.

Preferably, in the siloxane monomer, the radically polymerizable groups are present in a numerical fraction of between 80-90%, based on the number of all ester functions of the compounds of the formula (II).

The ethylenically unsaturated, radically polymerizable ester functions of radicals R³ in compounds of the formula (II) are preferably those selected from acrylic and/or methacrylic ester functions, more preferably acrylic ester functions.

The ester groups that are not radically polymerizable of the radicals R³ in compounds of the formula (II) are preferably monocarboxylic acid radicals. The ester groups that are not radically polymerizable are preferably selected from the acid radicals of the acids acetic acid, propionic acid, butyric acid, valeric acid and benzoic acid, more preferably acetic acid. More preferably, the monocarboxylic acid radicals are present in a numerical fraction of 3% to 20%, preferably 5% to 15%, based on the number of all ester functions of the compounds of the formula (II).

In some preferred embodiments, the siloxane monomer is a compound of formula (II) wherein

$$e = 2 ,$$

$$f = 0 ,$$

$$h = 4 to 15 ,$$

and the sum (g+h+2) is 5 to 40, preferably 10 to 30,
R³ denotes identical or different hydrocarbons which have 1 to 5 identical or different ester, the hydrocarbon being linear, cyclic, branched and/or aromatic, preferably linear or branched, and the ester being (meth-)acryloxy functions selected from ethylenically unsaturated, radically polymerizable ester, preferably (meth-)acryloxy functions and from ester groups which are not radically polymerizable; and
wherein the number of radically polymerizable groups in the siloxane monomer is 3 or more.

The organomodified silicones may be prepared by a process described in U.S. Pat. No. 10,465,032 B2 or U.S. Pat. No. 4,978,726.

A preferred example of the above described siloxane monomer can be TEGOMER® V-Si 7255, commercially available from Evonik Industries AG.

TEGOMER® V-Si 7255 is a comb-like acryloxyfunctional polysiloxane. The chemical name is: Siloxanes and Silicones, 3-[3-(acetyloxy)-2-hydroxypropoxy]propyl Me, di-Me, 3-[2-hydroxy-3-[(1-oxo-2-propen-1-yl)oxy]propoxy]propyl Me; CAS number: 125455-51-8.

Preferably, the weight ratio of the siloxane monomer to the macromonomer of the invention is from 1:0.4 to 1:80, especially from 1:0.8 to 1:52, preferably from 1:1.6 to 1:55, especially from 1:1.6 to 1:52, more preferably from 1:12.8 to 1:55, even more preferably from 1:20 to 1:52, especially from 1:12.8 to 1:52.

### Lithium Salt

The lithium salt is a material that is dissolved in the non-aqueous electrolyte to thereby resulting in dissociation of lithium ions.

The lithium salt may be those used conventional in the art but is thermally stable during in-situ polymerization (e.g. at 80° C.), non-limiting examples may be at least one selected from lithium bis(fluorosulfonyl) imide(LiFSI), lithium bis(trifluoromethanesulfonyl)imide (LiTFSI), lithium difluorooxalate borate (LiODFB), LiAsF₆, LiClO₄, LiN(CF₃SO₂)₂, LiBF₄, LiSbF₆, and LiCl, LiBr, Lil, LiB₁₀Cl₁₀, LiCF₃SO₃, LiCF₃CO₂, LiAlCl₄, CH₃SO₃Li, CF₃SO₃Li, (CF₃SO₂)₂NLi, chloroborane lithium, lower aliphatic carboxylic acid lithium, lithium tetraphenyl borate and imide. The lithium salt is preferably selected from LiTFSI, LiFSI and LiClO₄. These materials may be used alone or in any combination thereof.

### Free Radical Initiator

The free radical initiator of the polymerization reaction is for the thermal- or irradiation such as photo-polymerization reaction of the reactive monomers, and may be those conventional in the art.

Examples of free radical initiator or the polymerization initiator may include azo compounds such as 2,2-azobis(2-cyanobutane), 2,2-azobis(methylbutyronitrile), 2,2′-azoisobutyronitrile (AIBN), azobisdimethyl-valeronitrile (AMVN) and the like, peroxy compounds such as benzoyl peroxide, acetyl peroxide, dilauryl peroxide, di-tert-butyl peroxide, cumyl peroxide, hydrogen peroxide and the like, and hydroperoxides. Preferably, AIBN, 2,2′-azobis(2,4-dimethyl valeronitrile) (V65), Di-(4-tert-butylcyclohexyl)-peroxydicarbonate (DBC), or the like may also be employed.

Preferably the free radical thermal initiator may be selected from azobisisobutyronitrile (AIBN), azobisisoheptanenitrile (ABVN), benzoyl peroxide (BPO), lauroyl peroxide (LPO) and so on. More preferably, the free radical initiator is benzoyl peroxide (BPO) or azobisisobutyronitrile (AIBN).

The free radical photoinitiators produce free radicals when exposed to UV light, then setup the polymerization. Examples of photoinitiators may include benzoyl compounds such as 2,2-dimethoxy-1,2-diphenyl-ethan-1-one (DMPA), Benzil Dimethyl Ketal, diphenyl(2,4,6-trimethylbenzoyl)phosphine oxide (TPO), 2-hydroxy-2-methyl propiophenone (HMPP), 1-hydroxycyclohexyl phenyl ketone (HCPK), and the like may also be employed.

Preferably the free radical photoinitiator may be selected from 2,2-dimethoxy-1,2-diphenyl-ethan-1-one (DMPA), Benzil Dimethyl Ketal, diphenyl(2,4,6-trimethylbenzoyl)phosphine oxide (TPO) and so on. More preferably, the free radical photoinitiator is 2,2-dimethoxy-1,2-diphenyl-ethan-1-one (DMPA).

The amount of the free radical initiator is conventional. Preferably the amount of the free radical initiator is 0.1-3 wt. %, more preferably around 0.5 wt. % based on the total weight of the monomers of the copolymer.

In some embodiments, the amount of the photoinitiator or thermal initiator may be 0.2 wt. %-2 wt. %, preferably around 0.5 wt. % based on the total weight of the macromonomer of the invention and the siloxane monomer. The photoinitiator or thermal initiator generates free radicals to initiate polymerization under UV irradiation or heating.

In some embodiments, the polymerization initiator is decomposed at a certain temperature of 40 to 80° C. to form radicals, and may react with monomers via the free radical polymerization to form a polymer electrolyte. Generally, the free radical polymerization is carried out by sequential reactions consisting of the initiation involving formation of transient molecules having high reactivity or active sites, the propagation involving re-formation of active sites at the ends of chains by addition of monomers to active chain ends, the chain transfer involving transfer of the active sites to other molecules, and the termination involving destruction of active chain centers.

Preferably, the solid-state lithium secondary batteries can be coin batteries or pouch batteries.

The electrochemical device encompasses all kinds of devices that undergo electrochemical reactions. Examples of the electrochemical device include all kinds of primary batteries, secondary batteries, fuel cells, solar cells, capacitors and the like, preferably secondary batteries.

Generally, the secondary battery is fabricated by inclusion of the electrolyte in an electrode assembly composed of a cathode and an anode, which are faced opposite to each other with (or without for SPE) a separator therebetween.

The cathode is, for example, fabricated by applying a mixture of a cathode active material, a conductive material and a binder to a cathode current collector, followed by drying and pressing. If necessary, a filler may be further added to the above mixture.

The cathode current collector is generally fabricated to have a thickness of 3 to 500 μm. There is no particular limit to materials for the cathode current collector, so long as they have high conductivity without causing chemical changes in the fabricated battery. Examples of the materials for the cathode current collector may include stainless steel, aluminum, nickel, titanium, sintered carbon, and aluminum or stainless steel which was surface-treated with carbon, nickel, titanium or silver. The current collector may be fabricated to have fine irregularities on the surface thereof so as to enhance adhesion to the cathode active material. In addition, the current collector may take various forms including films, sheets, foils, nets, porous structures, foams and non-woven fabrics.

Examples of the cathode active materials that can be used in the present invention may include, but are not limited to, layered compounds such as lithium cobalt oxide (LiCoO₂) and lithium nickel oxide (LiNiO₂), or compounds substituted with one or more transition metals such as LiNiₓCo_{y}Mn_{1-x-y}(NCM); lithium manganese oxides such as compounds of Formula Li₁₊ₓMn₂₋ₓO₄ (0≤x≤0.33), LiMnO₃, LiMn₂O₃ and LiMnO₂; lithium copper oxide (Li₂CuO₂); vanadium oxides such as LiV₃O₈, V₂O₅ and Cu₂V₂O₇; Ni-site type lithium nickel oxides of Formula LiNi₁₋ₓMₓO₂ (M=Co, Mn, Al, Cu, Fe, Mg, B or Ga, and 0.01≤x≤0.3); lithium manganese composite oxides of Formula LiMn₂₋ₓMₓO₂ (M=Co, Ni, Fe, Cr, Zn or Ta, and 0.01≤x≤0.1), or Formula Li₂Mn₃MO₈ (M=Fe, Co, Ni, Cu or Zn); LiMn₂O₄ wherein a portion of Li is substituted with alkaline earth metal ions; disulfide compounds; and Fe₂(MoO₄)₃, LiFe₃O₄, etc.

In some embodiments, the cathode active material is selected from LiFePO₄, LiCoO₂, LiNi_{0.8}Mn_{0.1}Co_{0.1}O₂, LiNi_{0.6}Mn_{0.2}Co_{0.2}O₂, LiNi_{0.85}Co_{0.05}Al_{0.1}O₂, all are commercially available common cathode.

In some embodiments, the cathode slurry is obtained by blending cathode active material, super-p, binder and lithium perchlorate (LiClO₄) in a solvent, and then the slurry is loaded directly onto aluminum foil by blade casting and dried under vacuum for removing solvent. In some embodiments, the weight ratio of cathode active material, super-p, binder and LiClO₄ is (67%-89%):(5%-20%):(5%-10%):(1%-3%).

Preferably, the weight ratio of cathode active material, super-p, binder and LiClO₄ is 78.94%:9.87%:9.87%:1.32%.

Preferably, the solvent used in preparing the cathode slurry is acetonitrile or N-Methyl pyrrolidone. Usually, acetonitrile is used when the binder is PEO. N-Methyl pyrrolidone is used when the binder is PVDF.

Preferably, the temperature of drying cathode slurry is 60° C.~120° C. The time of drying cathode slurry can preferably be 10~24 hrs, more preferably is 12 hrs.

The conductive material is typically added in an amount of 1 to 50% by weight, based on the total weight of the mixture including the cathode active material. There is no particular limit to the conductive material, so long as it has suitable conductivity without causing chemical changes in the fabricated battery. Examples of conductive materials may include conductive materials including graphite such as natural or artificial graphite; carbon blacks such as carbon black, acetylene black, Ketjen black, channel black, furnace black, lamp black and thermal black; conductive fibers such as carbon fibers and metallic fibers; metallic powders such as carbon fluoride powder, aluminum powder and nickel powder; conductive whiskers such as zinc oxide and potassium titanate; conductive metal oxides such as titanium oxide; and polyphenylene derivatives.

The binder is a component assisting in binding between the active material and conductive material, and in binding with the current collector. The binder is typically added in an amount of 1 to 50% by weight, based on the total weight of the mixture including the cathode active material. Examples of the binder may include polyvinylidene fluoride, poly(ethylene oxide)(PEO), polyvinyl alcohols, carboxymethylcellulose (CMC), starch, hydroxypropylcellulose, regenerated cellulose, polyvinyl pyrollidone, tetrafluoroethylene, polyethylene, polypropylene, ethylene-propylene-diene terpolymer (EPDM), sulfonated EPDM, styrene butadiene rubber, fluoro rubber and various copolymers.

In some embodiments, the polymer binder is poly(ethylene oxide)(PEO) or poly(vinylidene fluoride)(PVDF).

The filler is an optional ingredient used to inhibit cathode expansion. There is no particular limit to the filler, so long as it does not cause chemical changes in the fabricated battery and is a fibrous material. As examples of the filler, there may be used olefin polymers such as polyethylene and polypropylene; and fibrous materials such as glass fiber and carbon fiber. The anode is fabricated by applying an anode active material to the anode current collector, followed by drying. If necessary, other components as described above may be further included.

The anode current collector is generally fabricated to have a thickness of 3 to 500 μm. There is no particular limit to materials for the anode current collector, so long as they have suitable conductivity without causing chemical changes in the fabricated battery. Examples of materials for the anode current collector may include copper, stainless steel, aluminum, nickel, titanium, sintered carbon, copper or stainless steel having a surface treated with carbon, nickel, titanium or silver, and aluminum-cadmium alloys. Similar to the cathode current collector, the anode current collector may also be processed to form fine irregularities on the surfaces thereof so as to enhance adhesive strength to the anode active material. In addition, the anode current collector may be used in various forms including films, sheets, foils, nets, porous structures, foams and non-woven fabrics.

Examples of the anode active materials utilizable in the present invention include carbon such as non-graphitizing carbon and graphite-based carbon; metal composite oxides such as LiₓFe₂O₃ (0≤x≤1), LiₓWO₂ (0≤x≤1) and SnₓMe₁₋ₓMe′_{y}O_{z} (Me: Mn, Fe, Pb or Ge; Me′: Al, B, P, Si, Group I, Group II and Group Ill elements of the Periodic Table of the Elements, or halogens; 0≤x≤1; 1≤y≤3; and 1≤z≤8); lithium metals; lithium alloys; silicon-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; and Li—Co—Ni based materials. In some examples of this invention, lithium metal is employed as anode.

The secondary battery according to the present invention may be, for example, a lithium metal secondary battery, a lithium-ion secondary battery, a lithium polymer secondary battery, lithium-ion polymer secondary battery or the like. The secondary battery may be fabricated in various forms. For example, the electrode assembly may be constructed in a jelly-roll structure, a stacked structure, a stacked/folded structure or the like. The battery may take a configuration in which the electrode assembly is installed inside a battery case of a cylindrical can, a prismatic can or a laminate sheet including a metal layer and a resin layer. Such a configuration of the battery is widely known in the art.

Using the macromonomer and the electrolyte precursor composition of the invention, a solid-polymer electrolyte with high ionic conductivity and good mechanical stability/strength may be prepared. In addition, the macromonomer and the electrolyte precursor composition of the invention is liquid and water free. No solvent is needed for handling the macromonomer and the electrolyte precursor composition of the invention. After crosslinking and a solid-polymer electrolyte is prepared using the electrolyte precursor composition of the invention, no removal of a solvent is necessary.

Due to the further crosslinking of the macromonomer with the siloxane monomer, the inventive solid-polymer electrolyte has much better mechanical performances than polymer electrolyte of prior arts using PEO polymer or PEOPO copolymer. The inventive solid-polymer electrolyte especially has better mechanical performances at temperatures above the melting points of PEO polymer or PEOPO copolymer, which losses its mechanical strength above the melting point.

Contrary to the solid-polymer electrolyte benchmark poly(ethylene oxide) (PEO), the inventive solid-state electrolyte does not has the ability to crystallize. The complete amorphous structure of the electrolyte of the invention shows superior ionic conductivity at lower temperatures. This is due to the absence of any crystalline domains which hinder the movement of ions at lower temperatures and the reduced complexation of the amorphous poly(ethylene glycol-co-propylene glycol) to the PEG or PEO structure. Furthermore, the comonomer propylene oxide in the polyether side chain of the invention reduces the chelatization of lithium ions and therefore increases their mobility. In contrast to the state-of-the-art, which concerned non-crosslinked polyethers with molecular weights below 15,000 g/mol that do not have any mechanical integrity above the melting point, the inventive macromonomer with the polyether side chain can be polymerized with the siloxane monomer to form high molecular weights with much better mechanical properties at such temperature. By crosslinking with a crosslinker, clear and highly elastic films can be obtained, which in a solid-state battery takes both the function of the electrolyte and separator. The elastic film can withstand deformation and improves therefore the safety of the battery.

The inventive process simplifies the production process and allows the manufacturer of lithium-ion batteries to use the established equipment for the lithium-ion batteries with liquid electrolytes. Compared with the conventional manufacturing process of lithium-ion batteries with liquid electrolytes, in the inventive process, the drying step is replaced by the crosslinking step, where the solid-state electrolyte forms from the monomer formulation. In addition, the electrolyte filling step is not needed anymore. Due to the simplified production process cell factory costs is expected to drop 20% lower than a current equivalent-capacity factory.

In the current battery production, a liquid electrolyte is handled. The described formulation can be also handled as a liquid before crosslinking. After it has been applied to the battery electrode it can be solidified by crosslinking. This simplifies the production process, as no additional solvents or extrusion equipment is needed.

The prepared solid-state electrolyte with high conductivity at room temperature helps to enable the electrification of mobility.

Other advantages of the present invention would be apparent for a person skilled in the art upon reading the specification.

### BRIEF DESCRIPTION OF DRAWINGS

FIG. 1 shows the ionic conductivities of crosslinked polymer electrolytes prepared in Examples 1-2 and Comparative Examples 1-3 at different temperatures.

### DETAILED DESCRIPTION OF THE INVENTION

The invention is now described in detail by the following examples. The scope of the invention should not be limited to the embodiments of the examples.

### Materials

The following materials were used in the examples.

VISIOMER® MPEG 1005 MA W represents methoxypolyethylene glycol 1000-methacrylate 50 wt. % in water. It is a highly polar monomer (50 wt. % in water) with excellent water solubility. The monomer may be represented by the formula (III) below

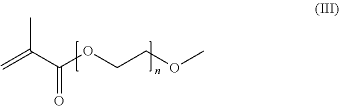

wherein the molecular weight is 1005. VISIOMER® MPEG 1005 MA W was freeze-dried to remover water and obtain a solid monomer.

VISIOMER® MPEG 2005 MA W represents methoxypolyethylene glycol 2000-methacrylate 50 wt. % in water. It is a highly polar monomer (50 wt. % in water) with excellent water solubility. The monomer may be represented by the formula (III) above, wherein the molecular weight is 2005. VISIOMER® MPEG 2005 MA W was freeze-dried to remover water and obtain a solid monomer.

Both VISIOMER® MPEG 1005 MA W and VISIOMER® MPEG 2005 MA W are commercially available from Evonik Industries AG.

### Analytical Procedures

The electrochemical impedance spectroscopy measurements were carried out using a SP-300 potentiostat (BioLogic Science Instruments) in a temperature range between 0 and 70° C. An impedance measurement was conducted over a frequency range from 1 MHz to 500 mHz (and reverse) with an amplitude of 20 mV. A heating cycle comprised of a gradual temperature increase in 10° C. steps from 0 to 70° C. The temperature was increased with a heating/cooling rate of 60° C. h⁻¹ over 10 min, after which the temperature was held constant for another 50 min to acquire impedance spectra. At a temperature of 70° C., the heating profile was reversed and gradually cooled down in similar temperature steps. The ionic conductivity σ was calculated according to equation:

$$σ = 1 / {R}_{b} * L / A$$

R_{b} is the bulk electrolyte resistance that can be accessed from the Nyquist plot, L is the film thickness, and A is the film area.

### Example 1

Synthesis of poly(ethylene glycol-co-propylene glycol)ether alcohol (methyl diglycol+16 EO/3 PO): In a 17-liter autoclave, 1556 g of methyl diglycol and 45.4 g of potassium methanolate catalyst were added and the reactor contents were inerted with nitrogen. The stirred reaction mixture was heated to 60° C. and stirred for 15 min. The reactor internal pressure was lowered to 100 mbar and the reaction mixture was heated to the reaction temperature of 115° C. Over a period of 2.5 h a mixture of 9595 g of ethylene oxide and 2370 g of propylene oxide was added with stirring and cooling to an internal temperature maximum of 115° C. and internal pressure of 2.3 bar (abs.). After the complete addition, the mixture was held at 115° C. for 1.5 h and subsequently the reaction mixture degassed. Volatile components such as residual ethylene oxide and propylene oxide were removed by distillation in vacuo. The alkaline product was cooled to 90° C., aqueous phosphoric acid was added for neutralization and the mixture stirred for 30 min. As antioxidant, 6.78 g of ANOX® 20 (a high molecular weight hindered phenolic antioxidant and primary stabilizer from SI Group) were added. Under reduced pressure (<20 mbar) and with increasing temperature up to 110° C., water was removed by distillation. The mixture was cooled to 70° C. and the precipitated phosphate salts were removed by filtration. The yield of liquid colorless polyether was 13.5 kg. The obtained poly(ethylene glycol-co-propylene glycol)ether alcohol had a hydroxyl value of 56.4 mg KOH/g and an acid value of 0.2 mg KOH/g.

Synthesis of poly(ethylene glycol-co-propylene glycol) methyl ether methacrylate 1000: The poly(ethylene glycol-co-propylene glycol)ether alcohol (4400 g, 4.40 mol, Mw 1000 g/mol) prepared above and methyl methacrylate (11013 g, 110.0 mol) were weighed into a reaction vessel. Hydroquinone monomethyl ether (MEHQ) (0.94 g, 200 ppm rel. to product) was added, and (lean) air was passed through the reaction mixture. Dehydration of the mixture can was conducted by azeotropic distillation of water/methyl methacrylate until initially present water is completely distilled off. The amount of methyl methacrylate distilled off during dehydration was replaced afterwards by addition of the appropriate amount to the mixture. The catalyst titanium tetraisopropoxide (44.0 g, 0.155 mol, 1 wt. % rel. to alcohol) was added and the mixture was heated to reflux, gradually distilling off a methanol/methyl methacrylate azeotrope. Full conversion of the starting material was achieved after 3 h. The mixture was cooled to 60° C.-85° C. and the catalyst was precipitated with diluted sulfuric acid (1 wt. %) under constant stirring. After neutralization with Na₂CO₃ (10 wt. %), a filtration aid (Celite) was added. Water and a portion of excess methyl methacrylate was distilled off, under vacuum and at elevated temperatures. The reaction mixture was then filtered using a pressure filtration device and residual solvent was removed under vacuum. The product was obtained as a clear liquid.

Yield: 4613 g (98 wt. %).

Water content: 0.015 wt. % (determined by Karl Fischer titration), GPC analysis coincided with the product and expected Mw distribution based on starting materials.

### Preparation of Solid-Polymer Electrolyte:

The prepared amorphous poly(ethylene glycol-co-propylene glycol) methyl ether methacrylate 1000 (840 mg, 84 wt % based on the total weight of the reaction mixture) was mixed with TEGOMER® V-Si 7255 (30 mg, 3 wt %), photo-initiator (phenyl-bis-(2,4,6-trimethylbenzoyl)-phosphinoxide, BAPOs) (30 mg, 3 wt %) and lithium bis(trifluoromethanesulphonyl) imide (LITFSI) (100 mg, 10 wt %). The mixture was stirred overnight in the dark, then dried at 60° C. overnight. The final material was poured directly on the top of a stainless-steel disk and then exposed to the light (TLC, λ=365 nm) for 3 h at room temperature.

### Example 2

A poly(ethylene glycol-co-propylene glycol)ether alcohol with a molecular weight double of that prepared in Example 1 was prepared using the same method as that of Example 1 except that only half of the amount of methyl diglycol alcohol and half of the amount of potassium methanolate catalyst described in Example 1 was used in Example 2.

### Synthesis of Poly(Ethylene Glycol-Co-Propylene Glycol) Methyl Ether Methacrylate 2000:

The poly(ethylene glycol-co-propylene glycol)ether alcohol (1437.8 g, 0.72 mol, Mw 2000 g/mol) prepared above and methyl methacrylate (3063.5 g, 30.6 mol) were weighed into a reaction vessel. MEHQ (0.297 g, 200 ppm rel. to product) was added, and (lean) air was passed through the reaction mixture. Calcium oxide (11.21 g, 200 mmol, 0.78% rel. to alcohol) and lithium chloride (3.16 g, 74.5 mmol, 0.22% rel. to alcohol) was added, and the mixture was heated to reflux while constantly distilling off the methanol/methyl methacrylate azeotrope. After 4-6 hours, full conversion was achieved and a filtration aid (Celite) was added. Under stirring, excess methyl methacrylate was distilled off under vacuum at elevated temperature and subsequently, the mixture was filtered using a pressure filtration device. Residual methyl methacrylate was removed under vacuum. The product was obtained as a clear liquid.

Yield: 1346 g (91 wt. %, losses on filter plate).

Water content: 0.01 wt. % (determined by Karl Fischer titration), GPC analysis coincided with the product and expected Mw distribution based on starting materials.

### Preparation of Solid-Polymer Electrolyte:

A solid-polymer electrolyte was prepared according to the same method of Example 1 except that amorphous poly(ethylene glycol-co-propylene glycol) methyl ether methacrylate 2000 was used as starting material.

### Example 3

### Synthesis of Poly(Ethylene Glycol-Co-Propylene Glycol) Methyl Ether Methacrylate 4000

The poly(oxyalkylen)ether alcohol (4008.6 g, 1.00 mol, Mw ~4068 g/mol) and methyl methacrylate (6019.3 g, 60.12 mol) were weighed into a reaction vessel. MEHQ (0.82 g, 200 ppm rel. to product) was added, and (lean) air was passed through the reaction mixture. Dehydration of the mixture was conducted by azeotropic distillation of water/methyl methacrylate until initially present water was completely distilled off. The amount of methyl methacrylate distilled off during dehydration was replaced afterwards by addition of the appropriate amount to the mixture.

The catalyst titanium tetraisopropoxide (40.1 g, 0.141 mol, 1 wt. % rel. to alcohol) was added and the mixture was heated to reflux, gradually distilling off a methanol/methyl methacrylate azeotrope. Full conversion of the starting material was achieved after 2 h. The mixture was cooled to 60° C.-85° C. and the catalyst was precipitated with diluted sulfuric acid (1 wt. %) under constant stirring. After neutralization with Na₂CO₃ (10 wt. %), a filtration aid (Tonsil) was added. Water and a portion of excess methyl methacrylate was distilled off, under vacuum and at elevated temperatures. The reaction mixture was then filtered (using a pressure filtration device) and residual solvent was removed under vacuum. The product was obtained as a clear liquid.

Yield: 3582 g (88 wt. %, losses on filter plate).

Water content: 0.03 wt. % (Karl Fischer), Ti<1 ppm (AES), MEHQ 177 ppm, GPC analysis coincided with product and expected Mw distribution based on starting material.

### Example 4

### Synthesis of Poly(Ethylene Glycol-Co-Propylene Glycol) Methyl Ether Methacrylate 4600

The poly(oxyalkylen)ether alcohol (874 g, 0.19 mol, Mw ~4600 g/mol) and methyl methacrylate (2377.9 g, 23.75 mol) were weighed into a reaction vessel. MEHQ (0.18 g, 200 ppm rel. to product) was added, and (lean) air was passed through the reaction mixture. Dehydration of the mixture was conducted by azeotropic distillation of water/methyl methacrylate until initially present water was completely distilled off. The amount of methyl methacrylate distilled off during dehydration was replaced afterwards by addition of the appropriate amount to the mixture.

LiCl (2.31 g, 0.05 mol, 0.26 wt. % rel. to alcohol) and CaO (8.18 g, 0.15 mol, 0.94 wt. % rel. to alcohol) were added and the mixture was heated to reflux, gradually distilling off a methanol/methyl methacrylate azeotrope. Full conversion of the starting material was achieved after 2.5 h, and excess methyl methacrylate was then partially distilled off (1101 g) at 200 mbar. The mixture was cooled to 60° C.-85° C. and a filtration aid (15.7 g Tonsil) was added. The mixture was stirred for 15 minutes and filtered (using a pressure filtration device). Residual methyl methacrylate was removed by distillation under vacuum. The product was obtained as a clear liquid.

Yield: 839.8 g (95 wt. %).

Water content: 0.02 wt. % (Karl Fischer), OH number <0.50, acid number 0.08, MEHQ 176 ppm, GPC analysis coincided with product and expected Mw distribution based on starting material, D=1.18.

### Comparative Example 1: PEO Electrolyte

Poly(ethylene oxide) (PEO) (Mw=200,000 g/mol) (900 mg, 90 wt. %) was mixed with lithium bis(trifluoromethanesulphonyl) imide (LITFSI) (100 mg, 10 wt. %) in 1 mL acetonitrile and stirred overnight. The mixture was then cast into a Teflon mold and dried in oven at 60° C. for 2 days to remove any trace of solvent prior to use. The ionic conductivities of were measured in CR2032 cells by sandwiching the solid electrolyte between two stainless steel (SS).

### Comparative Example 2: Photo-Crosslinked VISIOMER® MPEG 1005 MA Electrolyte

The freeze dried monomer VISIOMER® MPEG 1005 MA W(840 mg, 84 wt. % based on the total weight of the reaction mixture) was mixed with TEGOMER® V-Si 7255 (30 mg, 3 wt. %), photo-initiator (phenyl-bis-(2,4,6-trimethylbenzoyl)-phosphinoxide, BAPOs) (30 mg, 3 wt. %), and lithium bis(trifluoromethanesulphonyl) imide (LITFSI) (100 mg, 10 wt. %) and 0.5 mL acetonitrile was added to obtain a homogenous solution. The mixture was stirred overnight in the dark, then cast into a Teflon mold and dried in oven at 60° C. for 2 days to remove any trace of solvent prior to use. The material exposed to the light (TLC, λ=365 nm) for 3 h at room temperature.

### Comparative Example 3: Photo-Crosslinked VISIOMER® MPEG 2005 MA Electrolyte

The freeze dried monomer VISIOMER® MPEG 2005 MA W(840 mg, 84 wt. % based on the total weight of the reaction mixture) was mixed with TEGOMER® V-Si 7255 (30 mg, 3 wt. %), photo-initiator (phenyl-bis-(2,4,6-trimethylbenzoyl)-phosphinoxide, BAPOs) (30 mg, 3 wt. %), and lithium bis(trifluoromethanesulphonyl) imide (LITFSI) (100 mg, 10 wt. %) and 0.5 mL acetonitrile was added to obtain a homogenous solution. The mixture was stirred overnight in the dark, then cast into a Teflon mold and dried in oven at 60° C. for 2 days to remove any trace of solvent prior to use. The material exposed to the light (TLC, λ=365 nm) for 3 h at room temperature.

The electrochemical performance and mechanical properties of the electrolytes prepared in the examples and comparative examples were determined according to the methods as described above.

The ionic conductivities of the tested electrolytes were summarized in Table 1 below.

TABLE 1

| | Ionic conductivity in mS/cm | | | | | |
|---|---|---|---|---|---|---|
| Temperature | 0° C. | 10° C. | 20° C. | 30° C. | 40° C. | 50° C. |
| Example 1 | 2.8E−03 | 5.0E−03 | 7.0E−03 | 2.7E−02 | 4.1E−02 | 5.7E−02 |
| Example 2 | 7.9E−04 | 1.8E−03 | 4.4E−03 | 8.7E−03 | 2.1E−02 | 2.4E−02 |
| Comparative | 1.7E−04 | 7.2E−04 | 2.7E−03 | 8.3E−03 | 2.2E−02 | 4.3E−02 |
| Example 1 | | | | | | |
| Comparative | 1.5E−04 | 4.7E−04 | 1.8E−03 | 6.8E−03 | 2.6E−02 | 4.2E−02 |
| Example 2 | | | | | | |
| Comparative | 4.15E−04 | 1.62E−03 | 6.00E−03 | 3.80E−02 | 5.82E−02 | 8.26E−02 |
| Example 3 | | | | | | |

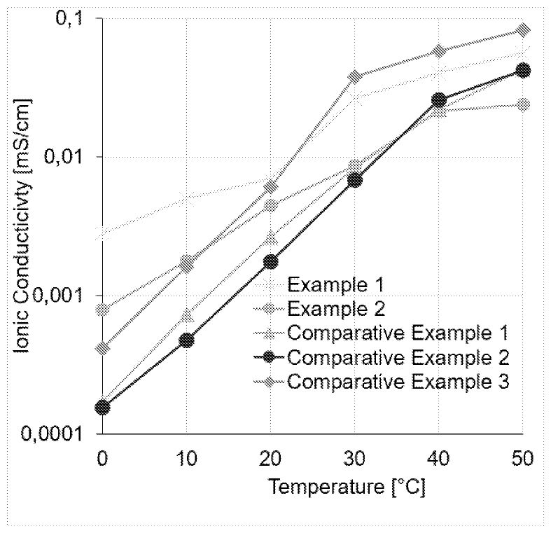

As shown in FIG. 1 and Table 1 above, the electrolyte prepared in Example 2 showed better ionic conductivity in different temperatures from 0-10° C. especially at low temperature 0° C. than the electrolyte prepared in Comparative Example 3, and even showed better ionic conductivity in different temperatures from 0° C. to 30° C. than those of Comparative Examples 1-2. More surprisingly, the electrolyte prepared in Example 1 showed much higher ionic conductivity at different temperatures from 0° C. to 50° C., especially at low temperatures of 0-20° C. than that of Comparative Example 2 and also showed better ionic conductivity than those of Comparative Examples 1 and 3 at least at low temperatures of 0-20° C.

Also as shown in FIG. 1, when the temperature decreased from 50° C. to 0° C., the decline of ionic conductivities of the electrolytes of Comparative Examples 1-3 was much more dramatic than those of Examples 1-2. Such ionic conductivity profile of the inventive electrolytes over temperature change is very advantageous, especially when the electrolyte is used in environments with low temperature or change between low and high temperatures.

On the other hand, the mechanical performances of the electrolytes of Examples 1-2 were much better than those of Comparative Examples 1-3. The electrolytes of Examples 1-2 were self-supportive, very elastic solids. The electrolyte films were very easy to handle with tools like tweezers and remained intact when handled by tweezers. By contrast, the electrolytes of Comparative Examples 1-3 were solid but were not elastic. When handled with tweezers, the electrolyte films were easy to be broken and should be handled very carefully.

As used herein, terms such as “comprise(s)” and the like as used herein are open terms meaning “including at least” unless otherwise specifically noted.

All references, tests, standards, documents, publications, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown but is to be accorded the widest scope consistent with the principles and features disclosed herein. In this regard, certain embodiments within the invention may not show every benefit of the invention, considered broadly.

1. A macromonomer, which is represented by the following general formula (I): 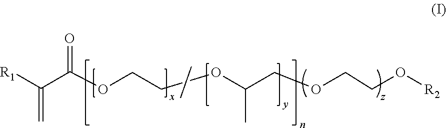
wherein R₁ represents methyl or H;
wherein z is a repeating number of an ethylene glycol spacer and represents 0, 1, 2, or 3;
R₂ represents methyl or a C2-C10 aliphatic or aromatic group;
n represents a positive integer from 10 to 200;
n defines a degree of a polymerization of a random copolymer with a ratio of comonomers x and y; and
y=1%-40%, x=1-y.

2. The macromonomer of claim 1, wherein a number average molecular weight of the macromonomer is from 500 to 10000.

3. The macromonomer of claim 1, wherein the macromonomer is liquid at room temperature.

4. The macromonomer of claim 1, wherein in formula (I), R₁ represents methyl or H;
z is the repeating number of an ethylene glycol spacer and represents 0, 1, 2, or 3;
R₂ represents methyl or a C2-C5 aliphatic group;
n represents a positive integer from 10 to 100; n defines the degree of polymerization of a random copolymer with the ratio of the comonomers x and y;
y=10%-25%, x=1-y; and
a number average molecular weight of the macromonomer is from 500 to 5000.

5. An electrolyte precursor composition, which comprises:
A) the macromonomer of claim 1;
B) a siloxane monomer; and
C) a lithium salt, and optionally
D) a free radical initiator.

6. The electrolyte precursor composition of claim 5, wherein the siloxane monomer is a compound of formula (II) 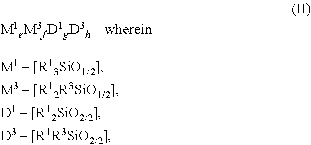
e=0 to 2,
f=0 to 2,
g=0 to 38,
h=0 to 20,
and a ratio of a sum (f+h) to a sum (g+h+2) is from 0.15 up to 1,
and the sum (g+h+2) is 4 to 40,
R¹ denotes identical or different aliphatic hydrocarbons having 1 to 10 carbon atoms or aromatic hydrocarbons having 6 to 12 carbon atoms,
R³ denotes identical or different hydrocarbons which have 1 to 5 identical or different ester, the hydrocarbon being linear, cyclic, branched and/or aromatic, and the ester being selected from an ethylenically unsaturated, a radically polymerizable ester, and from ester groups which are not radically polymerizable.

7. The electrolyte precursor composition of claim 5, wherein the siloxane monomer is a compound of formula (II) wherein:
$$e = 2 ,$$
$$f = 0 ,$$
$$h = 4 to 15 ,$$
and a sum (g+h+2) is 5 to 40,
R³ denotes identical or different hydrocarbons which have 1 to 5 identical or different ester, the hydrocarbon being linear, cyclic, branched and/or aromatic, and the ester being a (meth-)acryloxy functions elected from an ethylenically unsaturated, a radically polymerizable ester, and from ester groups which are not radically polymerizable; and
wherein a number of radically polymerizable groups in the siloxane monomer is 3 or more.

8. The electrolyte precursor composition of claim 5, wherein a weight ratio of the siloxane monomer to the macromonomer is from 1:0.4 to 1:80.

9. A method to prepare a solid-polymer electrolyte, comprising the following
a) providing the electrolyte precursor composition of claim 5; and
b) crosslinking said electrolyte precursor composition, in liquid form, with irradiation or thermal treatment under the presence of a free radical initiator.

10. A solid-polymer electrolyte prepared according to the method of claim 9, or obtained by curing an electrolyte precursor composition, which comprises:
A) a macromonomer, which is represented by the following general formula (I): 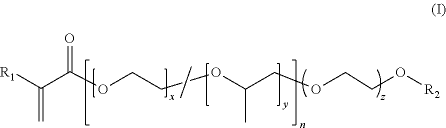
wherein R₁ represents methyl or H;
wherein z is a repeating number of an ethylene glycol spacer and represents 0, 1, 2, or 3;
R₂ represents methyl or a C2-C10 aliphatic or aromatic group;
n represents a positive integer from 10 to 200;
n defines a degree of a polymerization of a random copolymer with a ratio of comonomers x and y; and
y=1%-40%, x=1-y;
B) a siloxane monomer; and
C) a lithium salt, and optionally
D) a free radical initiator.

11. A solid-state lithium secondary battery, which comprises a cathode, a solid-copolymer electrolyte and an anode, wherein the solid-copolymer electrolyte is the solid-copolymer electrolyte according to claim 10.

12. An electrochemical device, comprising the solid-polymer electrolyte according to claim 10.

13. A device, comprising the electrochemical device according to claim 12.

14. A macromonomer composition, which comprises:
the macromonomer of claim 3, and
less than 5 wt. % of a solvent, based on a total weight of the macromonomer composition; and
wherein a number average molecular weight of the macromonomer is from 500 to 5000.

15. A method to improve performance in a lithium secondary battery, the method comprising:
mixing the macromonomer of claim 1 with a siloxane monomer and a lithium salt to form an electrolyte precursor composition, crosslinking the electrolyte precursor composition to prepare a solid-polymer electrolyte, and, incorporating the solid-polymer electrolyte in a lithium secondary battery.

16. The macromonomer of claim 1, wherein R₂ represents methyl or ethyl.

17. The macromonomer of claim 16, wherein R₂ represents methyl.

18. The macromonomer of claim 1, wherein n represents the positive integer from 10 to 100.

19. The macromonomer of claim 18, n represents the positive integer from 40 to 80.

20. The macromonomer of claim 1, wherein y=5%-25%.
